(19) United States
(12) Patent Application Publication
(10) Pub. No.: US 2024/0167936 A1
(43) Pub. Date: May 23, 2024

(54) CORROSION RATE MEASURING PROBE

(71) Applicant: Orlen S.A., Plock (PL)

(72) Inventors: Kazimierz DAROWICKI, Gdansk (PL); Juliusz ORLIKOWSKI, Gdynia (PL); Grzegorz LENTKA, Gdansk (PL); Mateusz CIESLIK, Olsztyn (PL); Andrzej DUL, Gdansk (PL); Radoslaw GOSPOS, Plock (PL); Iwona LUKSA, Plock (PL)

(21) Appl. No.: 18/282,234

(22) PCT Filed: Mar. 16, 2022
(86) PCT No.: PCT/PL2022/050015

§ 371 Date: Sep. 15, 2023

(30) Foreign Application Priority Data
Mar. 16, 2021 (EP) 21461525.4

(51) Int. Cl. G01N 17/04

(52) U.S. Cl. CPC G01N 17/04

(57) ABSTRACT

The probe comprises the first (3′ 4′) and second (3″, 4″) resistive element exposed to corrosive agents and the first (5′) and second (5″) reference resistive element isolated from said corrosive agents. All resistive elements of the probe are mechanically mounted in a common body (6) and, during the measurement, have substantially the same temperature. The first resistive element (3′, 4′) exposed to corrosive agents and the first reference resistive element (5′) are made of non-alloy steel with a carbon content not exceeding 0.002% by weight and manganese content not exceeding 0.05% by weight. The second resistive element (3″, 4″) exposed to corrosive agents and the second reference resistive element (5″) are made of non-alloy steel with a carbon content in range of 0.4 to 1% by weight and manganese content not exceeding 0.05% by weight.

The invention relates to a probe for measuring the corrosion rate of metal, particularly occurring in corrosive environment rich in hydrogen in atomic form.

The phenomenon of corrosive degradation of metal industrial installations is well known and attempts have been made to prevent it using various safety measures and constant control of corrosion level of such installations. One of the corrosion phenomena posing a more serious risk is the so-called hydrogen embrittlement which is the result of atomic hydrogen penetrating into the crystal structure of metal. In addition to the rapidly progressing decline in mechanical strength of the hydrogenated metal, this phenomenon also intensifies other types of corrosion. The hydrogenation of metal in the industrial installation originates from hydrogen present in atomic form, formed as a result of corrosion processes, or from hydrogen present in molecular form in the environment where the temperature exceeds 200° C. One of the commonly used methods of chemical corrosion rate testing is recording the increase in electrical resistance of a metal element introduced into a corrosive environment, resulting from corrosion cavities. Since the electrical resistance of metal has a strong temperature dependence, the current measured resistance of the corroding metal is compared with the resistance of an identical metal element located in the vicinity and thus under the same thermal conditions but protected from the influence of corrosive agents. Both metal elements, the corroding one and the reference one, are placed in the measuring probe, which is located in selected places in the installation monitored for corrosion. This type of probe, available on the market, is disclosed, for example, in Publication U.S. 69/972,962.

The hydrogenation process of steel based on the mechanism of: hydrogen embrittlement (HE), high temperature hydrogen attack (HTHA) is diagnosed mainly based on non-destructive testing methods. Due to the fact that the damage occurs most often locally, detectability of possible danger is low. In the case of cracks on the steel surface involved in hydrogen embrittlement, the following diagnostic methods are used: ultrasonic testing (UT), wet fluorescent magnetic particle testing (WFMT). To diagnose internal cracks, penetration testing (PT) and magnetic particle testing (MT) are used. All of the above methods for diagnosis and monitoring do not meet the market needs, because, in most cases, these studies are performed on a material that has undergone extensive degradation. In most cases, the diagnostic methods are used during maintenance downtimes. The result of degradation is analysed, and the causes of corrosion are not investigated. Therefore, it is not possible to counteract the corrosion processes. Additionally, the causes of degradation in the form of temporary malfunctions in the technological stream are often unknown. Another method is to measure the partial pressure of hydrogen in refinery streams. This solution allows determining the level of risk of high temperature hydrogen attack. However, this type of measurement does not allow determining the actual level of degradation. Correlation between the actual state and the data resulting from the hydrogen content in the stream and the temperature is not always present. This type of measurement does not allow determining the hydrogenation level in case of corrosion in the wet hydrogen sulphide environment, due to the absence of hydrogen in molecular form in the refinery streams. Another similar solution is to measure the partial pressure of hydrogen measured after the hydrogen passes through a sensor element made of structural steel. In this case, the presence of hydrogen indicates that hydrogen passed through the structural material. This type of approach is very imprecise, because the passage of hydrogen through the material is not highly correlated with its absorption. The absorption of hydrogen in steel is not linear as a function of time, therefore the correlation of hydrogen pressure measurements performed is not precise. Probe for resistive measurement of molecular hydrogen concentration is disclosed, among others, in Publication GB850064.

Publication GB215300A discloses a probe for resistive measurement of corrosion cavities, comprising two or three measuring electrodes, in which the elements exposed to the corrosive agents differ in thickness. In the initial step, the corrosion rate measurement is performed using the thinnest electrode, while the thicker second electrode and, optionally, an even thicker third electrode are subjected only to corrosion cavities, reducing their thickness. Because an excessive reduction of thickness of the measuring element has a negative effect on the measuring sensitivity of the resistive electrode, beyond a certain level of corrosion cavities of the first electrode, it is disconnected from the measuring system and further corrosion rate measurement is conducted using the second electrode and the third electrode, if needed. This solution radically increases the possible operating time of such a probe, however the mentioned publication does not contain any guidance as to how such an approach can be used for measuring of hydrogen corrosion, especially for simultaneous measuring of corrosion cavity rate and the hydrogenation of metal.

Publication entitled “(ER) Electrical Resistance Probes” [Cosasco, May 17, 2016, XP055745519] discloses a series of resistive corrosion probes made of various materials and used to measure corrosion cavity rates, however this publication also does not contain guidance as to how such electrodes can be used to measure the level of hydrogenation of a metal.

Publication authored by A I Marshakow et al., entitled “Monitoring of external corrosion of buried pipelines” [Journal of Corrosion Science and Engineering, 1.1.2015, XP055745821] discloses the principles of corrosion cavity measurement and electrochemical measurement of hydrogenation of pipeline material using the so called Devanathan-Stachurski cell with a metal membrane, through which hydrogen diffuses. Another example of electrochemical measurement of hydrogen stream diffusing through a metal membrane is disclosed in Publication No. WO 83/03007.

The object of the invention is to create a probe that will allow simultaneous measurement of the rate of corrosion causing material cavities, as well as corrosion resulting from hydrogenation.

This object is achieved by a probe according to the invention comprising at least one assembly of resistive elements connected electrically to each other, the assembly is comprised of one resistive element exposed to corrosive agents and one reference resistive element isolated from said corrosive agents, wherein both resistive elements of each resistive assembly are mechanically mounted in a common probe body and, during the measurement, have substantially the same temperature. The invention is based on the fact that the probe comprises the first and second resistive elements exposed to corrosive agents and respective first and second reference resistive elements, corresponding to said elements. The first resistive element exposed to corrosive agents and the first reference resistive element are made of non-alloy steel with a carbon content not exceeding 0.002% by weight and manganese content not exceeding 0.05% by weight. The second resistive element exposed to corrosive agents and the second reference resistive element are made of non-alloy steel with a carbon content in range of 0.4% to 1% by weight and manganese content not exceeding 0.05% by weight.

In one variant of the invention, all resistive elements are made of wire. The length of the first resistive element exposed to corrosive agents is equal to the length of the first reference resistive element. The cross-section area of the first resistive element exposed to corrosive agents is equal to the cross-section area of the first reference resistive element. The length of the second resistive element exposed to corrosive agents is equal to the length of the second reference resistive element. The cross-section area of the second resistive element exposed to corrosive agents is equal to the cross-section area of the second reference resistive element.

In further variants of the invention, the cross-section areas of all resistive elements are the same and/or lengths of all resistive elements are the same.

In another variant of the invention, resistive elements of the probe are made of wire with a square cross-section.

In another variant of the invention, the length of the wire section forming the resistive element is two hundred and fifty to two hundred and seventy times greater than the length of the side of the square defining the outline of the cross-section of said wire.

In another variant of the invention, the first resistive element exposed to corrosive agents and the first reference resistive element form two parts of the first measuring electrode in a form of a continuous section of wire, whereas the second resistive element exposed to corrosive agents and the second reference resistive element form two parts of the second measuring electrode in a form of a continuous section of wire.

In another variant of the invention, in each measuring electrode, the resistive element exposed to corrosive agents has an elongated “U” shape, and thus comprises its first and second arm. The reference resistive element in the same measuring electrode has a form of a rectilinear section of wire which is an elongation of the second arm of the resistive element exposed to corrosive agents.

In another variant of the invention, both measuring electrodes are located parallel to each other, wherein the shape and dimensions of both electrodes are the same.

In another variant of the invention, the measuring electrodes are rotated relative to each other by ninety angular degrees.

In another variant of the invention, the probe body is formed by a cylindrical member with through holes for the measuring electrodes, wherein both arms of each measuring electrode are located on one side of the cylindrical member, whereas the reference resistive elements of said electrodes are located on the other side of the cylindrical member.

In another variant of the invention, both reference resistive elements are located inside a tubular member connected to the body, wherein the space between the measuring electrodes and the inside of the tubular member and the inside of the through holes of the cylindrical member is filled with an agent resistant to corrosive agents.

In another variant of the invention, both arms of both measuring electrodes are located inside a perforated cover connected to the body.

In yet another variant of the invention, the cylindrical member comprises a first, second, third and fourth through hole, which are arranged evenly around the axis of the cylindrical member, wherein the free end of the first arm of the first electrode is located in the first through hole, while the end of the second arm of the first electrode is located in the third through hole, whereas the free end of the first arm of the second electrode is located in the second through hole, while the end of the second arm of the second electrode is located in the fourth through hole.

The invention allows determining the uniform corrosion rate and hydrogenation in real time (online). This enables optimisation of the amount of chemicals and a better assessment of the corrosion inhibitors and other anti-corrosive agents used. The invention increases the safety of the process and the crew operating the industrial installation and provides the possibility of planning maintenance downtimes and reducing failures, by anticipating the necessity to replace structural elements due to corrosion cavities in their thickness. Using real time measurement, the invention also facilitates assessment of the current corrosion aggressiveness of various raw materials and immediate response in case of detecting a corrosion risk.

The possibility to determine the hydrogen content of the structural material facilitates assessment of the effect of technological parameters of the process and the type of raw material on the hydrogen penetration into the material of the installation, and, as a result, it is possible to assess the degree of decrease in the strength parameters of the structural material resulting from the hydrogen content and to verify whether this decrease has not already reached a critical value.

The embodiment of the invention has been described in detail and illustrated in the attached drawings, without keeping the same scale in the individual figures.

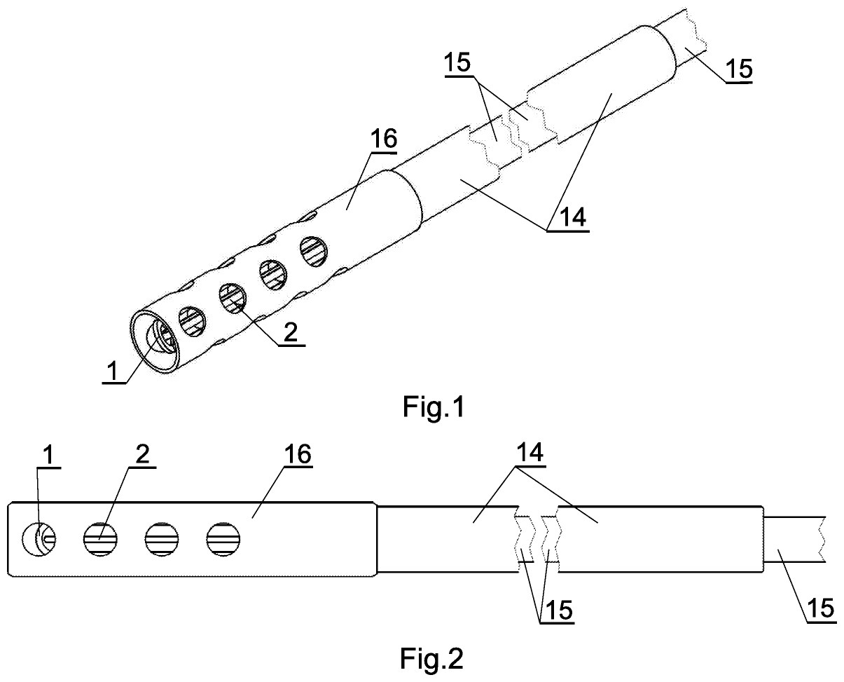

FIG. 1 shows a front axonometric view of the probe according to the invention,

FIG. 2 shows a side view of the probe,

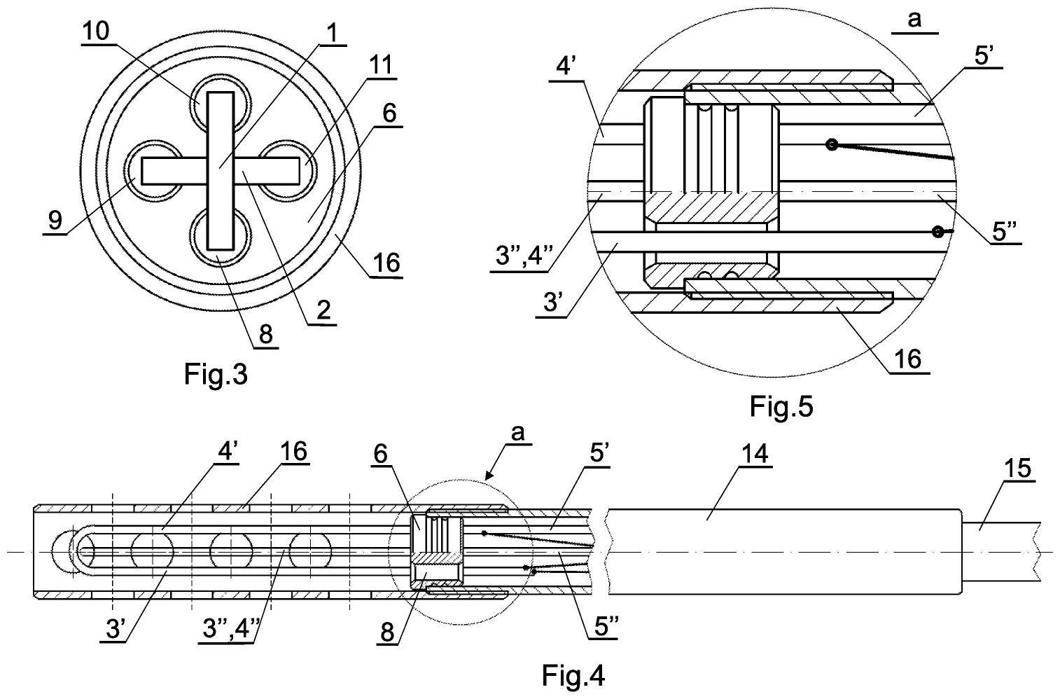

FIG. 3 shows a front view of the probe,

FIG. 4 shows a longitudinal cross-section of the probe and

FIG. 5 shows an enlarged portion of the cross-section in FIG. 4.

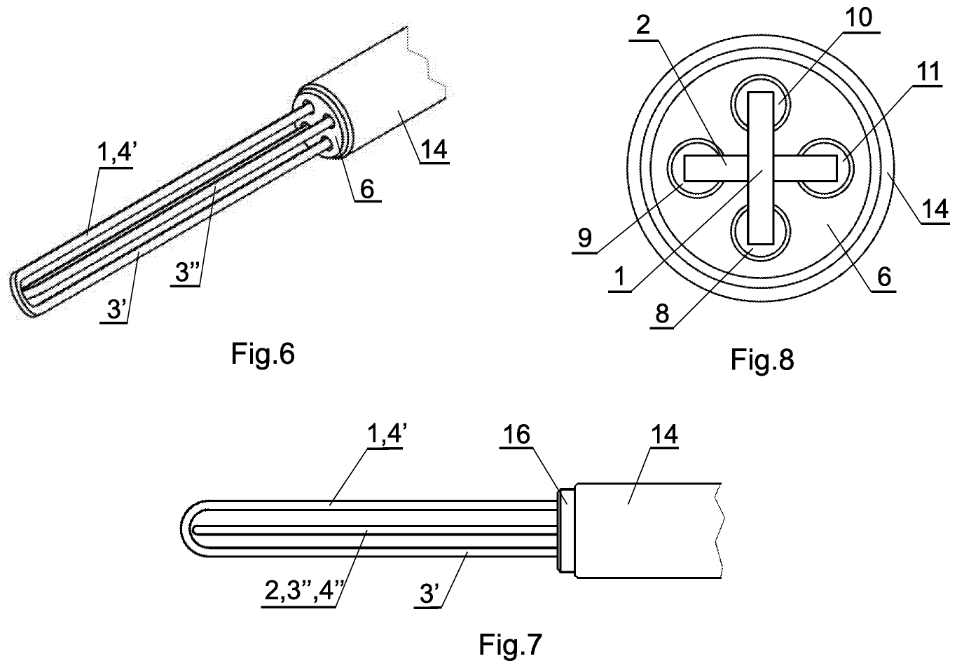

FIG. 6, FIG. 7, and FIG. 8 show portions of probe views in FIG. 1, FIG. 2, and FIG. 3, respectively, but with the electrode cover removed.

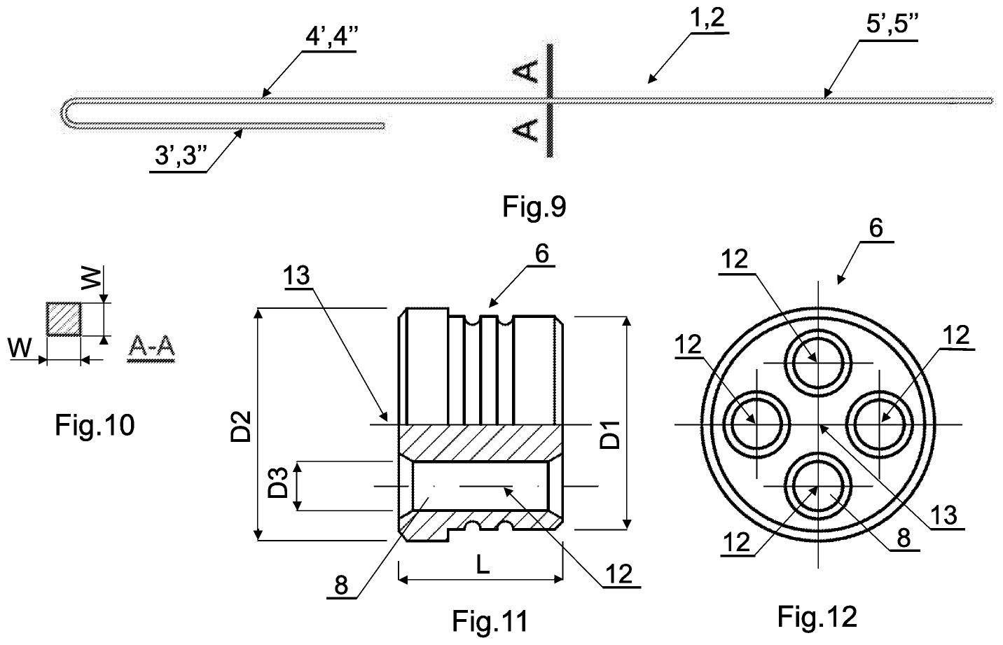

FIG. 9 shows a side view of the wire electrode of the probe, and

FIG. 10 shows the shape of wire cross-section of the electrode with a transverse plane to the wire axis.

FIG. 11 shows a side view of the probe body of FIG. 1, and

FIG. 12 shows the front view of the body.

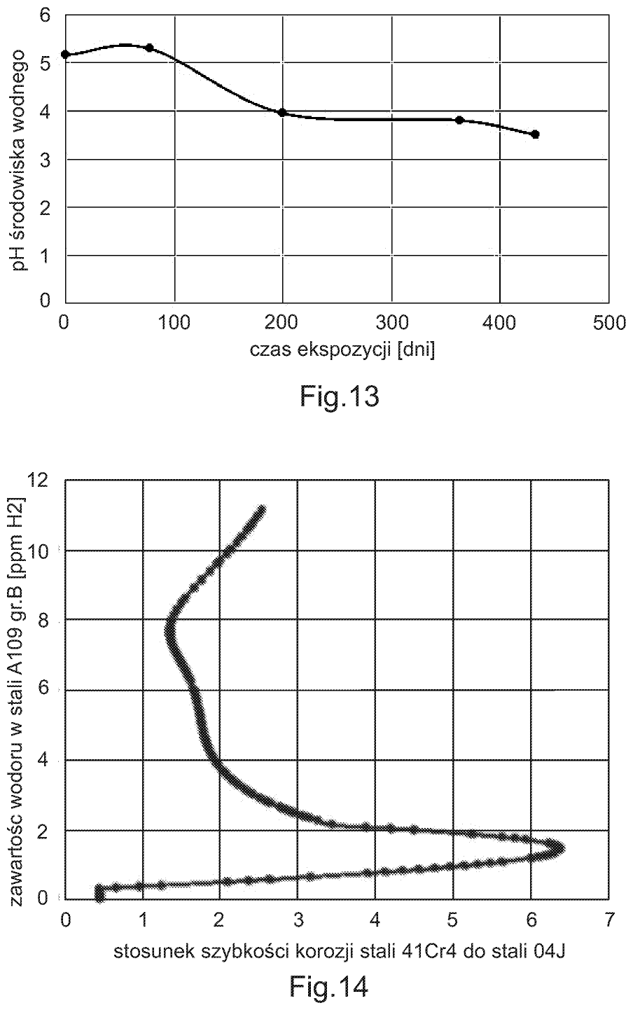

FIG. 13 shows a change of the pH value of the aqueous environment as a function of time occurring during calibration of the probe according to the invention, and

FIG. 14 shows the calibration curve of hydrogenation of A109 Grade B steel.

The exemplary probe according to the invention has two resistive measuring probes 1 and 2. One part of the electrode is exposed to corrosive agents, while its other part is insulated from this exposure and constitutes a reference element. The corrosion rate measurement in the probe according to the invention involves comparing the electrical resistance of the resistive element of the measuring electrode exposed to corrosive agents with the electrical resistance of the reference element of the same electrode. Both electrodes 1 and 2 are made of wire with a square cross-section. The side length W of this square cross-section is 1.5 mm. The total length of the rectilinear section of the wire forming each electrode 1 and 2 is about 400 mm, wherein, in each electrode 1 and 2, one of the ends, with a length of about 100 mm, is bent at an angle of 180 degrees, forming an elongated “U” shape with the adjacent part of the electrode, having a first arm 3 and a second arm 4. The section of the electrode wire forming the first 3 and second 4 arm of the letter “U” constitutes a resistive element exposed to corrosive agents, while the rectilinear section 5 of the wire, being an elongation of the second arm 4, constitutes a reference resistive element. In order to distinguish the individual fragments of the of the first 1 and second 2 electrode, these fragments have been designated as 3′, 4′, and 5′, and 3″, 4″ and 5″, respectively. The first electrode 1 is used to measure the so-called ordinary corrosion, i.e. resulting in material cavities, while the second electrode 2 is used to measure the so-called hydrogen corrosion, i.e. the level of metal hydrogenation. Consequently, in the probe according to the invention, the arms 3′ and 4′ of the first electrode 1 constitute the first resistive element exposed to corrosive agents, the rectilinear section 5′ of the first electrode 1 constitutes the first reference resistive element, the arms 3″ and 4″ of the second electrode 2 constitute the second resistive element exposed to corrosive agents, and the rectilinear section 5″ of the second electrode 2 constitutes the second reference resistive element. Electrode 1 is made of non-alloy steel with a carbon content not exceeding 0.002% by weight and a manganese content not exceeding 0.05% by weight, whereas the second electrode 2 is made of non-alloy steel with a carbon content in range of 0.4% to 1% by weight and a manganese content not exceeding 0.05% by weight. For example, the first electrode 1 can be made of steel type 06J, 03J, or 04J (Armco 1), and the second electrode 2 can be made of steel type 1.7053 (41Cr4), 1.7225, or 1.6511. Both electrodes 1 and 2 are mechanically embedded in a cylindrical body 6 made of stainless steel, e.g. steel type 1.4301, wherein the arms 3 and 4 of each electrode 1 and 2 are located on one side of the body 6, while the reference resistive elements 5 of the electrodes are located on the other side of the body 6. The body 6 has a form of a cylinder with a diameter D1 of 13 mm and a length L of 10 mm. At its first end, the cylinder has a flange 7 with a diameter D2 of approx. 14 mm. The body 6 has a first 8, second 9, third 10 and fourth 11 through hole, each with a diameter D3 of 2 mm. The axis 12 of each of the holes (8, 9, 10, 11) is parallel to the axis 13 of the body 6. The axes 12 of the holes 8, 9, 10, and 11 are located on a circle with a diameter of 8 mm, coaxial with the axis 13 of the body 6, and evenly spaced every 90 angular degrees. The free end of the first arm 3′ of the first electrode 1 is located in the first through hole 8, while the end of the second arm 4′ of the first electrode 1 is located in the third through hole 10. The free end of the first arm 3″ of the second electrode 2 is located in the second through hole 9, while the end of the second arm 4″ of the second electrode 2 is located in the fourth through hole 11. Thus, the first electrode 1 is rotated relative to the second electrode by 90 angular degrees. The body 6 is fitted into the tube 14 made of stainless steel of the same type as the steel of the body 6. The tube 14 surrounds the reference elements 5′ and 5″ of electrodes 1 and 2 and the starting section of an at least six-conductor signal cable 15, for example of the Olflex EB CY type. The individual wires of the cable 15 are connected to the electrodes 1 and 2 at their ends and at substantially half-length. The space between the electrodes 1 and 2 and the walls of the through holes 8, 9, 10, and 11 and the inner wall of the tube 14 is filled with a two-component epoxy resin, for example of the Belzona 1593 or 1391T type. The filling mounts the electrodes 1 and 2 mechanically in the housing 6 and protects the reference elements 5 and the electrical connections with the cable 15 from corrosive agents. The parts of the electrodes 1 and 2 that protrude from the body 6 are protected from damage by a perforated tubular cover 16, screwed onto the threaded end of the tube 14 adjacent to the body 6, and are also made of the same stainless steel as the body 6. The probe according to the invention is mounted in a known manner to the supervised structure in a place where corrosive agents are present, and the cable 15 is connected to a known measuring system, not shown in the drawing, that measures the electrical resistance of individual resistive elements 3, 4, and 5 of electrodes 1 and 2. A known wireless communication module may be connected to said measurement system, which relays the measurement results to a computer, which archives the received results and, based on said results, calculates the corrosion rate and visualizes it, for example, on a screen display.

The probe according to the invention described above was used to monitor a steel pipeline, made of non-alloy steel with the symbol A109 Grade B. The first electrode 1 in the mentioned probe was made of steel with the symbol 04J, which is essentially pure iron, denoted also as Armco steel, while the second electrode 2 of said probe was made of tool steel with the symbol 41Cr4, sometimes denoted with the symbol 1.7053. Before encasing the probe inside the pipeline, it has been calibrated for rate measurement of both types of corrosion of steel from which the pipeline was made (A109 Grade B). The calibration was a result of exposure tests of both electrodes 1, 2, and more specifically, testing their sections exposed to an environment of demineralised water saturated with hydrogen sulphide gas, sections 3′ and 4′, and 3″ and 4″, respectively. FIG. 13 shows a change of the pH value of the aqueous solution of hydrogen sulphide acting on the electrodes 1 and 2. During the calibration tests, parameters of the aqueous environment acting on the electrodes 1 and 2 of the calibrated probe were measured, namely the oxygen content, pH value and its conductivity. Apart from the electric resistance corrosimetry (ER) and linear polarization resistance (LPR) measurements of the electrodes 1 and 2, the effect of the mentioned aqueous environment on so called coupons was measured, i.e. metal samples which are subjected to laboratory tests after removing them from corrosive environment after a certain period of time. In the coupons, the level of corrosion cavity was studied and its hydrogenation level was measured using the vacuum extraction technique. The studies allowed developing an algorithm for determining the corrosion and hydrogenation rate of steel type A106 Grade B, based on the resistance measurement (ER) of electrodes 1 and 2 of the probe according to the invention. The measured resistances of both electrodes 1 and 2 were sent to the measuring system in a form of electrical voltages. The current values of these voltages were compared with their values measured before mounting the probe inside the installation, which allowed real-time determination of change in the electrical resistance over time for each electrode 1 and 2. To calculate the change of the resistance for each electrode, the following are recorded:
Uref₁—the initial voltage (before mounting) on section 5, i.e. on its reference resistive element,
Urefₙ—the current voltage measured on the reference element 5,
Ux₁—the initial voltage (before mounting) on the resistive element (comprised of sections 3 and 4) exposed to the corrosive environment,
Uxₙ—the current voltage measured on the resistive element exposed to the corrosive agents (3 and 4).

That is, for the specific probe, two measurement data series are recorded. Because both electrodes 1 and 2 are made of square wire, the value of its cross-section area is obtained by taking the square value of the of side length of this square. Thus, the initial cross-section area S₁ of sections 3 and 4 of the measuring electrode is equal to S₁=W₁×W₁, whereas the current area Sₙ of this cross-section is equal to Sₙ=Wₙ×Wₙ, where W₁ is the initial side length of the square of the outline of the cross-section (the thickness of the electrode), and Wₙ is the current thickness of the electrode, corresponding to the voltage Ux₁ measured on this electrode.

The current thickness Wₙ of the electrode can be calculated using the following formula:

$${W}_{n} = \sqrt{\frac{\frac{U {ref}_{n} \times {Ux}_{1} \times {S}_{1}}{{Uref}_{1}}}{{Ux}_{n}}}$$

Given the current thickness of each electrode, allows determining its corrosion cavity

ΔW=W₁−Wₙ

and conversion corrosion rate V_{corr} (in millimetres per year):

$${V}_{corr} = \frac{Δ W}{{T}_{n}}$$

where Tₙ is the time in years which elapsed from mounting the probe to the current moment. Using the corrosion rate for the current moment for both electrodes 1 and 2, the conversion corrosion rate of the material of the second electrode 2 (i.e. steel 41Cr4) and the conversion corrosion rate of the material of the first electrode (i.e. steel 04J) are determined. Based on the laboratory tests, a relationship of hydrogenation level of steel A109 Grade B as a function of the conversion corrosion rates ratio of the electrodes of the probe according to the invention was determined. This relationship, in a form of a so-called calibration curve, is shown in FIG. 14. Hydrogenation on a level of 12 ppm H2 is equivalent to the destruction of the steel element, therefore this value was taken as a state of complete hydrogenation (100%). The calibration curve from FIG. 14 and the calculated corrosion rate ratio allow determining the theoretical hydrogenation level of steel, from which the pipeline monitored by the probe according to the invention is made. It was found experimentally that the actual cavity corrosion rate of steel A109 Grade B is equal to 150% of the conversion corrosion rate calculated for the first electrode 1 in the manner described above.

1. A resistive probe for corrosion rate measurement, comprising at least one assembly of resistive elements connected electrically to each other, the assembly is comprised of one resistive element exposed to corrosive agents and one reference resistive element isolated from said corrosive agents, wherein in said probe both resistive elements of each resistive assembly are mechanically mounted in a common probe body and, during the measurement, have substantially the same temperature, and wherein the resistive probe further comprises the first and second resistive element exposed to corrosive agents and respective first and second reference resistive element, corresponding to said elements, wherein the first resistive element exposed to corrosive agents and the first reference resistive element are made of non-alloy steel with carbon content not exceeding 0.002% by weight and manganese content not exceeding 0.05% by weight, whereas the second resistive element exposed to corrosive agents and the second reference resistive element are made of non-alloy steel with carbon content in range of 0.4 to 1% by weight and manganese content not exceeding 0.05% by weight.

2. The probe according to claim 1, wherein all resistive elements are made of wire, the length of the first resistive element exposed to corrosive agents is equal to the length of the first reference resistive element, the cross-section area of the first resistive element exposed to corrosive agents is equal to the cross-section area of the first reference resistive element, the length of the second resistive element exposed to corrosive agents is equal to the length of the second reference resistive element, while the cross-section area of the second resistive element exposed to corrosive agents is equal to the cross-section area of the second reference resistive element.

3. The probe according to claim 2, wherein the cross-section areas of all resistive elements are the same.

4. The probe according to claim 2, wherein the lengths of all resistive elements are the same.

5. The probe according to claim 4, wherein the resistive elements are made of wire with a square cross-section.

6. The probe according to claim 5, wherein the length of the wire section forming the resistive element is two hundred and fifty to two hundred and seventy times greater than the length of the side of the square defining the outline of the cross-section of said wire.

7. The probe according to claim 4, wherein the first resistive element exposed to corrosive agents and the first reference resistive element form two parts of the first measuring electrode in a form of a continuous section of wire, whereas the second resistive element exposed to corrosive agents and the second reference resistive element form two parts of the second measuring electrode in a form of a continuous section of wire.

8. The probe according to claim 7, wherein in each measuring electrode, the resistive element exposed to corrosive agents has an elongated “U” shape, and thus comprises its first and second arm, while the reference resistive element has a form of a rectilinear section of wire being an elongation of the second arm of the resistive element exposed to corrosive agents.

9. The probe according to claim 8, wherein both measuring electrodes are located parallel to each other, wherein the shape and dimensions of both electrodes are the same.

10. The probe according to claim 9, wherein the measuring electrodes are rotated relative to each other by ninety angular degrees.

11. The probe according to claim 10, wherein the probe body is formed by a cylindrical member with through holes for the measuring electrodes, wherein both arms of each measuring electrode are located on one side of the cylindrical member, whereas the reference resistive elements of said electrodes are located on the other side of the cylindrical member.

12. The probe according to claim 11, wherein both reference resistive elements are located inside the tubular member connected to the body, wherein the space between the measuring electrodes and the inside of the tubular member and the inside of the through holes of the cylindrical member is filled with an agent resistant to corrosive agents.

13. The probe according to claim 11, wherein both arms of both measuring electrodes are located inside a perforated cover connected to the body.

14. The probe according to claim 11, wherein the cylindrical member comprises a first, second, third and fourth through hole, which are arranged evenly around the axis of the cylindrical member, wherein the free end of the first arm of the first electrode is located in the first through hole, while the end of the second arm of the first electrode is located in the third through hole, whereas the free end of the first arm of the second electrode is located in the second through hole, while the end of the second arm of the second electrode is located in the fourth through hole.
